(19) United States
(12) Patent Application Publication
(10) Pub. No.: US 2026/0321516 A1
(43) Pub. Date: Oct. 15, 2026

(54) ELECTROLYTIC CAPACITOR AND METHOD FOR MANUFACTURING SAME

(71) Applicant: ELNA CO., LTD., Chuo-ku, Tokyo (JP)

(72) Inventor: Shinichiroh ITOH, Nishishirakawa-gun, Fukushima (JP)

(21) Appl. No.: 19/101,401

(22) PCT Filed: Jul. 4, 2023
(86) PCT No.: PCT/JP2023/024766

§ 371 Date: Feb. 5, 2025

(30) Foreign Application Priority Data
Sep. 22, 2022 (JP) 2022-151814

(51) Int. Cl. H01G 9/02; H01G 9/00; H01G 9/025; H01G 9/035; H01G 9/145; H01G 9/15

(52) U.S. Cl. CPC H01G 9/02; H01G 9/0036; H01G 9/025; H01G 9/035; H01G 9/145; H01G 9/151

(57) ABSTRACT

An electrolytic capacitor is characterized by including a capacitor element including an anode foil and a cathode foil that are wound with a separator, which holds a conductive polymer layer, interposed therebetween, wherein the major component of the separator is glass fibers having a porosity of 75 to 90%.

### TECHNICAL FIELD

The present invention relates to an electrolytic capacitor using a conductive polymer and a method for manufacturing the same.

### BACKGROUND ART

An electrolytic capacitor has, for example, a structure wherein a capacitor element in which an anode foil and a cathode foil constituted by aluminum foil are wound with a separator interposed therebetween, is impregnated with an electrolyte solution and assembled in an exterior case together with a sealing body. Aluminum electrolytic capacitors using a conductive polymer include solid electrolytic capacitors which hold a conductive polymer within a capacitor element, and hybrid electrolytic capacitors which hold a conductive polymer and an electrolyte solution within a capacitor element (see Patent Literatures 1 and 2).

### Background Art Literature

### Patent Literature

Patent Literature 1: Japanese Unexamined Patent Application Publication No. 2022-59471
Patent Literature 2: International Publication No. 2017/090241

### SUMMARY OF THE INVENTION

### Problems to be Solved by the Invention

For example, a separator made of cellulose fibers or the like, which has been used in aluminum electrolytic capacitors that use a conductive polymer, has poor acid resistance and is decomposed by a strongly acidic polymer. When a solid electrolytic capacitor is manufactured using such a separator, there is a fear that the fibers of the separator will rapidly deteriorate due to chemical polymerization, for example in the process of chemically polymerizing a monomer with an oxidizing agent to produce a conductive polymer layer.

Also, with a method different from the above, which involves immersing a capacitor element in a dispersion liquid of a conductive polymer and then drying the capacitor element, a separator may deteriorate rapidly after manufacture of the capacitor element due to dissolution of the conductive polymer. For example, in the case of a hybrid electrolytic capacitor in which a conductive polymer layer has been formed using the above-described dispersion liquid, the conductive polymer is likely to dissolve into, e.g., an electrolyte solution contained in a separator. As the electrolyte solution evaporates, the acidity of the electrolyte solution increases due to the conductive polymer which dissolves from the conductive polymer layer into the electrolyte solution. This accelerates deterioration of the separator and promotes its decomposition.

As decomposition of the separator thus proceeds due to its acidification, there is a fear of, for example, a decrease in the amount of the conductive polymer retained, resulting in an increase in the ESR. Further, there is also a fear of a decrease in the amount of the electrolyte solution retained, resulting in an increase in leakage current.

Accordingly, the present invention has been made in view of the above problems. It is therefore an object of the present invention to provide a highly reliable electrolytic capacitor which inhibits acidification of a separator, and a method for manufacturing the capacitor.

### Means for Solving the Problems

The electrolytic capacitor of the present invention is characterized by comprising a capacitor element including an anode foil and a cathode foil that are wound with a separator, which holds a conductive polymer layer, interposed therebetween, wherein a major component of the separator is glass fibers having a porosity of 75 to 90(%).

In the electrolytic capacitor, the porosity of the glass fibers may be 85 to 90%.

In the electrolytic capacitor, the separator may hold an electrolyte solution, and the average fiber diameter of the glass fibers may be 0.5 to 1 (μm).

In the electrolytic capacitor, the glass fibers may comprise at least one of borosilicate glass, alkali-free borosilicate glass, and high-silica glass.

In the electrolytic capacitor, the separator may contain at least one of polyester fibers, polyethylene fibers, polypropylene fibers, aramid fibers, acrylic fibers, and cellulose fibers.

In the electrolytic capacitor, the separator may contain, as a binder, at least one of polyvinyl alcohol, polyvinyl butyral, polyvinylpyrrolidone, polyurethane, polyvinylidene fluoride, a styrene-butadiene rubber, and an acrylic resin.

In the electrolytic capacitor, the capacitor element may be impregnated with an electrolyte solution containing at least one of ethylene glycol, γ-butyrolactone, and sulfolane.

The electrolytic capacitor manufacturing method of the present invention characterized by comprising a step of winding an anode foil and a cathode foil with a separator interposed therebetween to produce a capacitor element; a step of immersing the capacitor element in a dispersion liquid or solution of a conductive polymer; and a step of drying the capacitor element, wherein a major component of the separator is glass fibers having a porosity of 75 to 90(%).

In the manufacturing method, the porosity of the glass fibers may be 85 to 90(%).

The manufacturing method may further comprise the step of immersing the capacitor element in an electrolyte solution, and in the manufacturing method, the average fiber diameter of the glass fibers may be 0.5 to 1 (μm).

In the manufacturing method, the glass fibers may comprise at least one of borosilicate glass, alkali-free borosilicate glass, and high-silica glass.

In the manufacturing method, the separator may contain at least one of polyester fibers, polyethylene fibers, polypropylene fibers, aramid fibers, acrylic fibers, and cellulose fibers.

In the manufacturing method, the separator may contain, as a binder, at least one of polyvinyl alcohol, polyvinyl butyral, polyvinylpyrrolidone, polyurethane, polyvinylidene fluoride, a styrene-butadiene rubber, and an acrylic resin.

In the manufacturing method, the capacitor element may be impregnated with an electrolyte solution containing at least one of ethylene glycol, γ-butyrolactone, and sulfolane.

### Effects of the Invention

According to the present invention, it is possible to inhibit the acidification of a separator, thereby enhancing the reliability.

### BRIEF DESCRIPTION OF THE DRAWINGS

FIG. 1 is a side view showing an example of an aluminum electrolytic capacitor.

FIG. 2 is a perspective view showing an example of a capacitor element.

FIG. 3 is a diagram showing an example of a process for manufacturing an aluminum electrolytic capacitor.

### MODE FOR CARRYING OUT THE INVENTION

### Embodiments

### (Configuration of Aluminum Electrolytic Capacitor)

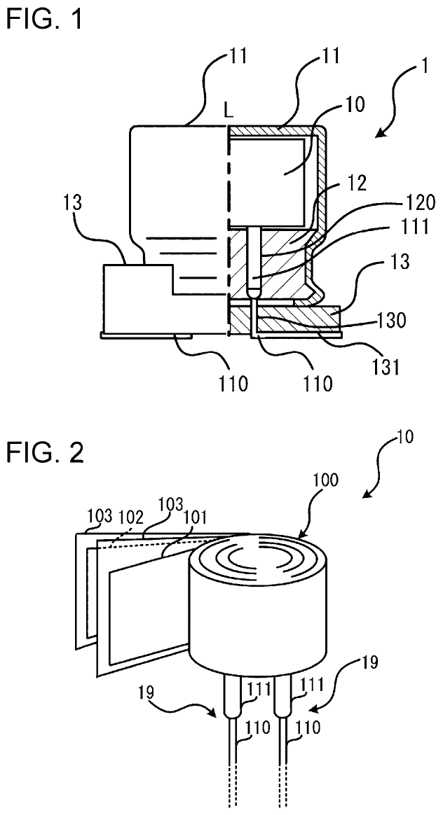

FIG. 1 is a side view showing an example of an aluminum electrolytic capacitor 1. FIG. 1 shows, on the right side of the center line L of the aluminum electrolytic capacitor 1 on paper, a cross-section of the interior of the right half of the aluminum electrolytic capacitor 1.

The aluminum electrolytic capacitor 1 is a conductive polymer solid aluminum electrolytic capacitor (hereafter referred to as a solid electrolytic capacitor) or a conductive polymer hybrid aluminum electrolytic capacitor (hereafter referred to as a hybrid electrolytic capacitor). The aluminum electrolytic capacitor 1 is to be mounted on an electronic circuit board and to be used, for example, for coupling, decoupling, or smoothing.

The aluminum electrolytic capacitor 1 includes a capacitor element 10, a case 11, a sealing body 12, a seat plate 13, a pair of bar-like portions 111, and a pair of lead portions 110. The bar-like portions 111 and the lead portions 110 constitute extraction electrodes for the capacitor element 10, the lead portions 110 extending from the front ends of the bar-like portions 111. It should be noted that while only one of the bar-like portions 111 is shown in FIG. 1, the other bar-like portion 111 is provided at a position symmetrical to the center line L.

The case 11 is made of aluminum and has a closed-top cylindrical shape. The case 11 covers the capacitor element 10 and the sealing body 12, and functions as the exterior of the aluminum electrolytic capacitor 1. It should be noted that the shape of the case 11 is not limited to a cylindrical shape, and may be a polygonal cylinder shape.

The sealing body 12 is a roughly circular member made of an elastic material such as butyl rubber. The sealing body 12 is located adjacent to the capacitor element 10 and seals the bottom opening of the case 11.

The capacitor element 10 has a configuration obtained by winding a stack of an anode foil, a cathode foil, and a separator (electrolytic paper), as described below. The pair of bar-like portions 111 extend from the bottom of the capacitor element 10.

The bar-like portions 111 and the lead portions 110 are bar-like members made of aluminum or the like. The pair of bar-like portions 111 are joined to the anode foil and the cathode foil by a joining method such as caulking, and function as an anode terminal and as a cathode terminal, respectively, of the aluminum electrolytic capacitor 1. The bar-like portions 111 are inserted into a pair of through holes 120 formed in the sealing body 12. It should be noted that while only one of the through holes 120 is shown in FIG. 1, the other through hole 120 is provided at a position symmetrical to the center line L.

The lead portions 110 each have a flat plate-like shape which is bent in an “L” shape, with the front end-side portion extending along a plate face of the seat plate 13. The bar-like portion 111-side portion of each lead portion 110 is inserted into a through hole 130 in the seat plate 13. The lead portions 110 are soldered to a pad on an electronic circuit board during a reflow process performed on the electronic circuit board.

The seat plate 13 is a plate-like member, e.g. made of a resin, and is provided under the case 11 and the sealing body 12. The seat plate 13 supports the case 11 and the sealing body 12 on an electronic circuit board on which they are mounted. The seat plate 13 has through holes 130 for the lead portions 110 and groove parts 131 for housing the bent front end-side portions of the lead portions 110. The groove parts 131 each extend outward from a position near the center of the seat plate 13 along the bottom face of the seat plate 13. The bottom face of the seat plate 13 serves as a mounting face of the aluminum electrolytic capacitor 1 to the electronic circuit board; the plate-like lead portions 110 can be soldered to a pad on the electronic circuit board. It should be noted that while the aluminum electrolytic capacitor 1 of this embodiment is of a surface-mount type, the below-described examples can also be applied to a lead type without the seat plate 13.

### (Configuration of the Capacitor Element)

FIG. 2 is a perspective view showing an example of the capacitor element 10. In FIG. 2, the same configurations as those of FIG. 1 are given the same reference numerals, and a description thereof is omitted. The capacitor element 10 includes a wound body 100 composed of an anode foil 101, a cathode foil 102, and a separator (electrolytic paper) 103 which have been wound, and a pair of extraction electrodes 19 connected to the anode foil 101 and the cathode foil 102.

The pair of extraction electrodes 19 extend below the wound body 100. The bar-like portions 111 of the extraction electrodes 19 are connected to the anode foil 101 and the cathode foil 102. It should be noted that FIG. 2 shows the wound body 100 before its lead portions 110 are each bent and press-processed into a flat plate-like shape.

The anode foil 101 and the cathode foil 102 may each be, for example, a foil of a valve metal such as aluminum, tantalum, titanium, or niobium, or an alloy thereof, or a vapor-deposited foil of such a metal. The surface of the anode foil 101 has been subjected to an etching treatment in order to increase the electrode area. This ensures that the capacitor element 10 has a predetermined capacitance. An extremely thin oxide film has been formed on the surface of the anode foil 101. Therefore, the anode foil 101 is insulated from other components. The oxide film functions as a dielectric, allowing the capacitor element 10 to function as a capacitor.

On the other hand, the surface of the cathode foil 102 has been subjected to an etching treatment. However, no oxide film has been formed on the surface of the cathode foil 102. It should be noted that an oxide film, or an inorganic layer, or a carbon layer may be formed on the surface of the cathode foil 102.

The separator 103, when it is wound, is sandwiched between the anode foil 101 and the cathode foil 102. In the case of a solid electrolytic capacitor, the separator 103 holds a conductive polymer. In the case of a hybrid electrolytic capacitor, the separator 103 holds a conductive polymer and an electrolyte solution. The major component constituting the separator 103 is glass fibers having a porosity of 75 to 90(%), which may also contain other organic fibers, a binder, and the like. Since the major component of the separator 103 is glass fibers, it is less likely to acidify as compared to the case of using cellulose fibers, for example, as the major component.

The porosity of the glass fibers is 75 to 90(%). As used herein, porosity refers to the ratio of the volume of pores or voids to the total volume of the fibers. If the porosity is less than 75(%), the glass fibers cannot hold a sufficient amount of a conductive polymer and an electrolyte solution, leading to an increase in the ESR. Also, if the porosity is more than 90(%), the glass fibers can hold a sufficient amount of a conductive polymer and an electrolyte solution, leading to a sufficient reduction in the ESR. On the other hand, the separator 103 undesirably cannot have a strength necessary for its winding.

Thus, when the porosity of the glass fibers is 75 to 90(%), the ESR is appropriately reduced due to the increased amount of the conductive polymer and electrolyte solution retained. The porosity of the glass fibers is preferably made 85 to 90(%). This allows the separator 103 to hold a larger amount of a conductive polymer, resulting in a further reduction in the ESR. The reliability of the aluminum electrolytic capacitor 1 can therefore be enhanced.

Also, the average fiber diameter of the glass fibers is 0.5 to 1 (μm). If the fiber diameter exceeds 1 (μm), the evaporation rate of an electrolyte solution will be excessively high, resulting in a high density of a conductive polymer that has dissolved from a conductive polymer layer into the electrolyte solution. This progresses the acidification of the separator. On the other hand, if the fiber diameter is less than 0.5 (μm), the retention of a conductive polymer will be undesirably poor and not appropriate. Accordingly, by making the average fiber diameter of the glass fibers 0.5 to 1 (μm), the evaporation of an electrolyte solution is appropriately inhibited, resulting in inhibited acidification of the separator.

Also, the thickness of the separator 103 is 40 (μm). If the thickness of the separator 103 is less than 40 (μm), the excessively small thickness leads to a low withstand voltage.

The glass fibers comprise at least one of borosilicate glass, alkali-free borosilicate glass, and high-silica glass. The use of such a material as a main component of the separator 103 has the advantage of improved acid resistance.

Further, the separator 103 may also contain at least one of polyester fibers, polyethylene fibers, polypropylene fibers, aramid fibers, acrylic fibers, and cellulose fibers. The inclusion of such a material in the separator 103 has the advantage that the separator 103 has excellent solvent resistance and improved mechanical strength such as tensile strength.

The separator 103 may also contain, as a binder, at least one of polyvinyl alcohol, polyvinyl butyral, polyvinylpyrrolidone, polyurethane, polyvinylidene fluoride, a styrene-butadiene rubber, and an acrylic resin. The inclusion of such a binder in the separator 103 has the advantage that the separator 103 has excellent solvent resistance and improved mechanical strength such as tensile strength.

Also, when the aluminum electrolytic capacitor 1 is a solid electrolytic capacitor, the separator 103 is impregnated with an electrolyte solution. The solvent of the electrolyte solution may comprise at least one of ethylene glycol, γ-butyrolactone, and sulfolane. The impregnation of the separator 103 with an electrolyte solution containing such a solvent has the advantage of lower evaporation as compared to the use of a conventional electrolyte solution.

### (Electrolytic Capacitor Manufacturing Process)

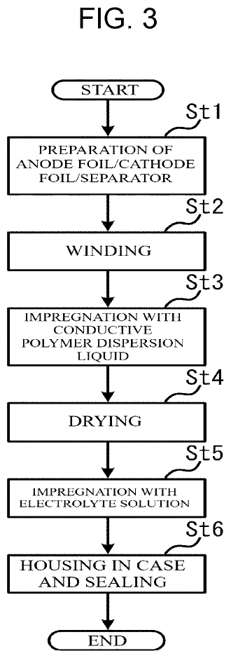

FIG. 3 is a diagram showing an example of a process for manufacturing the aluminum electrolytic capacitor 1. The process for manufacturing the aluminum electrolytic capacitor 1 is an example of an electrolytic capacitor manufacturing method. This example illustrates a manufacturing process for a hybrid electrolytic capacitor. It is to be noted that in the case of a manufacturing process for a solid electrolytic capacitor, the below-described step St6 is omitted.

First, an anode foil 101, a cathode foil 102, and a separator 103 are prepared (step St1). The surface of the anode foil 101 has been subjected to an etching treatment, and an oxide film as a dielectric layer has been formed on the surface of the anode foil 101. Also, the separator 103 has a porosity of 75 to 90(%) and its major component is glass fibers. Here, the porosity is preferably 85 to 90(%). Also, the average fiber diameter of the glass fibers is preferably 0.5 to 1 (μm) from the viewpoint of good electrolyte solution evaporation rate and conductive polymer impregnation. Also, the thickness of the separator 103 is 40 (μm).

Next, the separator 103, the anode foil 101, the cathode foil 102, and the separator 103 are stacked in this order and wound, and the outer surface is fixed with a winding-head fixing tape to produce a wound body 100 (step St2). During winding, extraction electrodes 19 are connected to appropriate positions on the anode foil 101 and the cathode foil 102. Caulking is an exemplary non-limiting method for performing the connection.

Next, the wound body 100 is immersed in a conductive polymer dispersion liquid containing water and an organic solvent for 20 minutes in a reduced pressure atmosphere, and then the wound body 100 is pulled up from the conductive polymer dispersion liquid (step St3). In this manner, the wound body 100 can be impregnated with the conductive polymer. It should be noted that in this step, a conductive polymer solution may be used instead of the conductive polymer dispersion liquid.

Next, the wound body 100 is placed in a drying oven e.g. at 150 degrees and dried for 60 minutes (step St4). The drying causes conductive polymers in the separator 103 to bind together to form a conductive polymer layer, thereby forming a conductive path.

Next, the wound body 100 is impregnated with a predetermined amount of an electrolyte solution in a reduced pressure atmosphere (step St5). It should be noted that the electrolyte solution may be a mixture of the conductive polymer dispersion liquid and a solute. Thus, the conductive polymer dispersion liquid can be used as an electrolyte solution. In that case, the impregnation with the electrolyte solution is performed simultaneously with the impregnation with the conductive polymer.

Next, the wound body 100 is housed in a case 11 and sealed with a sealing body 12 (step St6). The extraction electrodes 19 extending from the wound body 100 are inserted into through holes 120 of the sealing body 12. Thereafter, an aging treatment may be performed while applying a rated voltage to the capacitor element 10. A manufacturing process for the aluminum electrolytic capacitor 1 is performed in this manner.

### Examples

Next, examples of the aluminum electrolytic capacitor 1 will now be described. Samples No. 1 to 8 of the aluminum electrolytic capacitor 1 were manufactured according to the above-described manufacturing method. Also, for comparison, aluminum electrolytic capacitor samples Nos. 9 and 10 were manufactured using special rayon fibers (finely divided cellulose fibers) and cellulose fibers, respectively, instead of glass fibers as a main component of the separator 103. The rated voltage and rated capacitance of samples Nos. 1 to 10 were 63 (V) and 56 (μF), respectively. The diameter of the case 11 was 10 (mm), and the height of the case 11 was 10 (mm). The manufacturing method for the aluminum electrolytic capacitor 1 will be described specifically below.

### (Production of Wound Body)

An anode extraction electrode was connected to an anode foil which had undergone an etching treatment and on which an oxide film had been formed. A cathode extraction electrode was connected to a cathode foil which had a conductor layer on its end surfaces and which had undergone a pretreatment to improve wettability. Thereafter, a separator, the cathode foil, a separator, and the anode foil were stacked in this order, and the stack was wound while wrapping around the extraction electrodes, and the outer surface was fixed with a winding-head fixing tape to produce a wound body. The thickness of the separator, and the fiber diameter and porosity of fibers as a main component of the separator were varied among samples.

The wound body was immersed in an aqueous solution of ammonium phosphate, and a chemical conversion treatment of the anode foil was performed again at 85° C. while applying a predetermined voltage to the anode foil, thereby forming a dielectric layer mainly on the end surfaces of the anode foil.

(Impregnation with Conductive Polymer)

The wound body was immersed in a dispersion liquid of a conductive polymer, housed in a given container, in a reduced pressure atmosphere (−93 kPa), and then the wound body was pulled up from the dispersion liquid. Subsequently, the wound body impregnated with the conductive polymer was dried for 60 minutes in a drying chamber at 150° C., so that conductive polymers in each layer were bound together to form a conductive path. A capacitor element that functions as a solid electrolytic capacitor was thus produced.

(Impregnation with Electrolyte Solution)

Further, the above capacitor element was impregnated with a predetermined amount of an electrolyte solution (ESE2 manufactured by Tayca Corporation) in a reduced pressure atmosphere. A capacitor element that functions as a hybrid aluminum electrolytic capacitor was thus produced.

### (Sealing of Capacitor Element)

The capacitor element impregnated with the electrolyte solution was sealed to complete an electrolytic capacitor. Thereafter, an aging treatment was performed at a predetermined temperature for a predetermined time while applying a rated voltage to the capacitor element.

### (Evaluation)

Samples Nos. 1 to 10 were each evaluated as a solid electrolytic capacitor and as a hybrid electrolytic capacitor. Using an LCR meter for four-terminal measurement, the ESR (mΩ) of each sample was measured for the solid electrolytic capacitor and for the hybrid electrolytic capacitor at an electrolytic capacitor frequency of 100 kHz in an environment at 20° C. In addition, the amount of polymer (conductive polymer) retained (g) was measured for evaluation of the solid electrolytic capacitor, and the rate of evaporation of the electrolyte solution (g/h) at 150° C. was measured for evaluation of the hybrid electrolytic capacitor. Table 1 shows the measurement results for the solid electrolytic capacitors, and Table 2 shows the measurement results for the hybrid electrolytic capacitors.

TABLE 1

| | Main | Fiber | Weight | | | Withstand | Amount of | | |
|---|---|---|---|---|---|---|---|---|---|
| | component of | diameter | ratio | Thickness | Porosity | voltage | polymer | ESR | |
| No. | separator | (μm) | (%) | (μm) | (%) | (V) | retained (g) | (Ω) | Decision |
| 1 | Glass fibers | 0.5 | 75 | 40 | 90 | 500 | 0.0576 | 0.020 | OK |
| 2 | | 0.5 | 75 | 40 | 85 | 500 | 0.0541 | 0.024 | OK |
| 3 | | 0.5 | 75 | 40 | 79 | 600 | 0.0508 | 0.027 | OK |
| 4 | | 0.5 | 65 | 40 | 78 | 500 | 0.0534 | 0.025 | OK |
| 5 | | 1.2 | 75 | 40 | 77 | 500 | 0.0538 | 0.022 | OK |
| 6 | | 0.5 | 75 | 30 | 76 | 400 | 0.0422 | 0.021 | OK |
| 7 | | 1.0 | 75 | 40 | 75 | 500 | 0.0517 | 0.023 | OK |
| 8 | | 0.5 | 75 | 40 | 70 | 600 | 0.0452 | 0.031 | NG |
| 9 | Special rayon | 2.0 | 100 | 40 | 68 | 500 | 0.0465 | 0.030 | NG |
| | fibers | | | | | | | | |
| 10 | Cellulose | 5.0 | 100 | 40 | 57 | 400 | 0.0406 | 0.036 | NG |
| | fibers | | | | | | | | |

Table 1 shows the results of evaluation for samples Nos. 1 to 10 as solid electrolytic capacitors. The major components of the separators of samples Nos. 1 to 8 were glass fibers, while the major components of the separators of samples Nos. 9 and 10 were special rayon fibers and cellulose fibers, respectively. Also, the ratio of the weight of the main fibers to the weight of the entire separator (see the weight ratios in Table 1) was 100(%) for samples Nos. 9 and 10, 65(%) for sample No. 4, and 75(%) for the other samples.

The fiber diameter is the average diameter of the main fibers of the separator, and was measured in a plan view of the separator at 5000-fold magnification using a scanning electron microscope (SEM). The fiber diameters of samples Nos. 1 to 4, 6, and 8 were 0.5 (μm), the fiber diameter of sample No. 5 was 1.2 (μm), and the fiber diameter of sample No. 7 was 1.0 (μm). The fiber diameter of sample No. 9 was 2.0 (μm), and the fiber diameter of sample No. 10 was 5.0 (μm). The thickness of the separator of sample No. 6 was 30 (μm), and the thickness of the separators of the other samples was 40 (μm).

The porosity of the separator was varied among samples. For samples Nos. 1 to 4 and 8, the higher the porosity of the separator, the larger the amount of polymer retained tends to be and the lower the ESR tends to be. However, though samples Nos. 5 and 7 have a lower porosity than sample No. 4, they exhibited a larger amount of polymer retained and a lower ESR. This is because samples Nos. 5 and 7 have a larger fiber diameter, and therefore exhibit enhanced impregnation with the polymer. Though sample No. 6 has a lower porosity than sample No. 4, it has a lower ESR because of its smaller thickness, and thus shorter conductive path.

The ESR quality of each of samples Nos. 1 to 8, which are examples according to the present invention, was determined whether it is good or not good (OK/NG) based on the ESRs of samples Nos. 9 and 10 which are comparative examples (see the “decision” data in the Table). Samples Nos. 1 to 7 were determined to be OK because of their lower ESRs than those of samples No. 9 and 10. Sample No. 8 was determined to be NG because its ESR was higher than that of sample No. 9 despite the fact that its thickness was the same as that of sample No. 9 and its porosity was higher than that of sample No. 9. Sample No. 1, which had a porosity of 90(%), and sample No. 2, which had a porosity of 85(%), had a large amount of polymer retained, resulting in a favorable reduction in ESR.

Thus, a favorable reduction in ESR was achieved by samples Nos. 1 to 7 having a porosity of 75 to 90(%). Further, a favorable reduction in ESR was achieved by samples Nos. 1 and 2 having a porosity of 85 to 90(%).

The thickness of sample No. 6 is smaller than those of samples Nos. 1 to 5, 7, and 8. Therefore, the withstand voltage of sample No. 6 was lower than that of sample No. 9 which is a comparative example. On the other hand, the withstand voltages of samples Nos. 1 to 5, 7, and 8 were equal to or higher than that of comparative sample No. 9. Therefore, the thickness of the separator is preferably 40 (μm).

TABLE 2

| | | | | | | Amount of | | | |
|---|---|---|---|---|---|---|---|---|---|
| | | | | | | electrolyte | | Electrolyte | |
| | Main | Fiber | Weight | | | solution | | solution | |
| | component of | diameter | ratio | Thickness | Porosity | retained | | evaporation | |
| No. | separator | (μm) | (%) | (μm) | (%) | (g) | ESR (Ω) | rate (g/h) | Decision |
| 1 | Glass fibers | 0.5 | 75 | 40 | 90 | 0.2613 | 0.018 | 0.0239 | OK |
| 2 | | 0.5 | 75 | 40 | 85 | 0.2480 | 0.022 | 0.0234 | OK |
| 3 | | 0.5 | 75 | 40 | 79 | 0.2261 | 0.026 | 0.0228 | OK |
| 4 | | 0.5 | 65 | 40 | 78 | 0.2374 | 0.025 | 0.0226 | OK |
| 5 | | 1.2 | 75 | 40 | 77 | 0.2301 | 0.018 | 0.0310 | OK |
| 6 | | 0.5 | 75 | 30 | 76 | 0.1893 | 0.019 | 0.0198 | OK |
| 7 | | 1.0 | 75 | 40 | 75 | 0.2276 | 0.021 | 0.0279 | OK |
| 8 | | 0.5 | 75 | 40 | 70 | 0.1980 | 0.030 | 0.0206 | NG |
| 9 | Special rayon | 2.0 | 100 | 40 | 68 | 0.2034 | 0.029 | 0.0307 | NG |
| | fibers | | | | | | | | |
| 10 | Cellulose | 5.0 | 100 | 40 | 57 | 0.1779 | 0.031 | 0.0354 | NG |
| | fibers | | | | | | | | |

Table 2 shows the results of evaluation for samples Nos. 1 to 10 as hybrid electrolytic capacitors. The contents of Table 2 are the same except for the data on “amount of electrolyte solution retained”, “ESR”, “electrolyte solution evaporation rate”, and “decision”.

As in the case of the solid electrolytic capacitors, for samples Nos. 1 to 4 and 8, the higher the porosity of the separator, the larger the amount of electrolyte solution retained tends to be and the lower the ESR tends to be. However, though samples Nos. 5 and 7 have a lower porosity than sample No. 4, they exhibited a larger amount of electrolyte solution retained and a lower ESR. This is because samples Nos. 5 and 7 have a larger fiber diameter, and therefore exhibit enhanced impregnation with the polymer. Though sample No. 6 has a lower porosity than sample No. 4, it has a lower ESR because of its smaller thickness, and thus its shorter conductive path.

The ESR quality (OK/NG) of each of samples Nos. 1 to 8, which are examples according to the present invention, was determined based on the ESRs of samples Nos. 9 and 10 which are comparative examples (see the “decision” in the Table). Samples Nos. 1 to 7 were determined to be OK because of their lower ESRs than samples No. 9 and 10. Also, sample No. 8 was determined to be NG because its ESR was higher than that of sample No. 9 despite the fact that its thickness was the same as that of sample No. 9 and its porosity was higher than that of sample No. 9.

Thus, a favorable reduction in ESR was achieved by samples Nos. 1 to 7 having a porosity of 75 to 90(%). Further, a favorable reduction in ESR was achieved by samples Nos. 1 and 2 having a porosity of 85 to 90(%) due to their large amount of polymer retained.

Also, the evaporation rate of an electrolyte solution increases with increase in the fiber diameter. This is because as the fiber diameter increases, the contact area of the fibers with the electrolyte solution decreases, resulting in a reduction in the retention of the electrolyte solution. As the electrolyte solution evaporates, the acidity increases due to the increase in the density of the conductive polymer which has dissolved from the conductive polymer layer into the electrolyte solution. This promotes the acidification of the separator.

In comparison with the evaporation rates of the electrolyte solution in comparative samples Nos. 9 and 10, the evaporation rate of the electrolyte solution in sample No. 5, which had the largest fiber diameter among samples Nos. 1 to 8, was higher than that of sample No. 9. This is because the fiber diameter of sample No. 5 is larger than those of samples Nos. 1 to 4 and 6 to 8. On the other hand, the evaporation rates of the electrolyte solution in samples Nos. 1 to 4 and 6 to 8 were lower than those of samples Nos. 9 and 10. Thus, the evaporation of the electrolyte solution was appropriately inhibited and the acidification was inhibited by making the average fiber diameter of the glass fibers 0.5 to 1 (μm). It is not appropriate to make the average fiber diameter less than 0.5 (μm), because it leads to a reduction in the impregnation of the polymer.

While the present invention has been described in detail by reference to the examples, the present invention is not limited to the particular examples, and variations and modifications are possible within the scope and spirit of the present invention as set forth in the claims.

1. An electrolytic capacitor characterized by comprising a capacitor element including an anode foil and a cathode foil that are wound with a separator, which holds a conductive polymer layer, interposed therebetween, wherein a major component of the separator is glass fibers having a porosity of 75 to 90%.

2. The electrolytic capacitor according to claim 1, wherein the porosity of the glass fibers is 85 to 90%.

3. The electrolytic capacitor according to claim 1, characterized in that the separator holds an electrolyte solution, and the average fiber diameter of the glass fibers is 0.5 to 1 μm.

4. The electrolytic capacitor according to claim 1, characterized in that the glass fibers comprise at least one of borosilicate glass, alkali-free borosilicate glass, and high-silica glass.

5. The electrolytic capacitor according to claim 1, characterized in that the separator contains at least one of polyester fibers, polyethylene fibers, polypropylene fibers, aramid fibers, acrylic fibers, and cellulose fibers.

6. The electrolytic capacitor according to claim 1, characterized in that the separator contains, as a binder, at least one of polyvinyl alcohol, polyvinyl butyral, polyvinylpyrrolidone, polyurethane, polyvinylidene fluoride, a styrene-butadiene rubber, and an acrylic resin.

7. The electrolytic capacitor according to claim 3, characterized in that the capacitor element is impregnated with the electrolyte solution containing at least one of ethylene glycol, γ-butyrolactone, and sulfolane.

8. A method for manufacturing an electrolytic capacitor, characterized by comprising:
a step of winding an anode foil and a cathode foil with a separator interposed therebetween to produce a capacitor element;
a step of immersing the capacitor element in a dispersion liquid or solution of a conductive polymer; and
a step of drying the capacitor element,
wherein a major component of the separator is glass fibers having a porosity of 75 to 90%.

9. The method for manufacturing an electrolytic capacitor according to claim 8, characterized in that the porosity of the glass fibers is 85 to 90%.

10. The method for manufacturing an electrolytic capacitor according to claim 8, further comprising the step of immersing the capacitor element in an electrolyte solution, characterized in that the average fiber diameter of the glass fibers is 0.5 to 1 μm.

11. The method for manufacturing an electrolytic capacitor according to claim 8, characterized in that the glass fibers comprise at least one of borosilicate glass, alkali-free borosilicate glass, and high-silica glass.

12. The method for manufacturing an electrolytic capacitor according to claim 8, characterized in that the separator contains at least one of polyester fibers, polyethylene fibers, polypropylene fibers, aramid fibers, acrylic fibers, and cellulose fibers.

13. The method for manufacturing an electrolytic capacitor according to claim 8, characterized in that the separator contains, as a binder, at least one of polyvinyl alcohol, polyvinyl butyral, polyvinylpyrrolidone, polyurethane, polyvinylidene fluoride, a styrene-butadiene rubber, and an acrylic resin.

14. The method for manufacturing an electrolytic capacitor according to claim 10, characterized in that the capacitor element is impregnated with the electrolyte solution containing at least one of ethylene glycol, γ-butyrolactone, and sulfolane.
